(19) United States
(12) Patent Application Publication
(10) Pub. No.: US 2015/0151741 A1
(43) Pub. Date: Jun. 4, 2015

(54) AUTONOMOUS MOVING OBJECT, CONTROL METHOD THEREOF, AND NON-TRANSITORY RECORDING MEDIUM

(71) Applicant: TOYOTA JIDOSHA KABUSHIKI KAISHA, Toyota-shi (JP)

(72) Inventors: Tetsuya TAIRA, Nisshin-shi (JP); Yutaka TAKAOKA, Toyota-shi (JP)

(21) Appl. No.: 14/548,641

(22) Filed: Nov. 20, 2014

(30) Foreign Application Priority Data
Nov. 29, 2013 (JP) 2013-247527

(51) Int. Cl. B60W 30/00

(52) U.S. Cl. CPC B60W 30/00

(57) ABSTRACT

An autonomous moving object includes: a drive unit configured to drive wheels of a moving object body; a plurality of distance measuring units installed to face a road surface and configured to measure a distance to the road surface; a control unit configured to compare the distance measured by the distance measuring units with a threshold value and to control the drive unit; a tilt angle detecting unit configured to detect a tilt angle of the moving object body; and a correction unit configured to correct at least one of the distance measured by each distance measuring unit and the threshold value depending on the tilt angle of the moving object body detected by the tilt angle detecting unit.

### INCORPORATION BY REFERENCE

The disclosure of Japanese Patent Application No. 2013-247527 filed on Nov. 29, 2013 including the specification, drawings and abstract is incorporated herein by reference in its entirety.

### BACKGROUND OF THE INVENTION

1. Field of the Invention

The present invention relates to an autonomous moving object that autonomously moves, a control method thereof, and a non-transitory recording medium thereof.

2. Description of Related Art

An autonomous moving object is known which prevents a drop or a fail due to a level difference by detecting the level difference and performing a stopping or avoiding operation when the distance to a road surface measured by a distance measuring unit is greater than a threshold value (for example, Japanese Patent Application Publication No. 2012-130781 (JP 2012-130781A)).

### SUMMARY OF THE INVENTION

However, for example, when the autonomous moving object runs on a convex part and is tilted, the distance measured by the distance measuring unit increases in comparison with the case where the autonomous moving object runs on a horizontal road surface. Accordingly, in spite of the absence of a concave stepped portion, the distance measured by the distance measuring unit is greater than the threshold value and the concave stepped portion may be erroneously detected. The invention provides an autonomous moving object that can accurately detect a level difference even in a state where the autonomous moving object is tilted, a control method thereof, and a non-transitory recording medium thereof.

A first aspect of the invention relates to an autonomous moving object. The autonomous moving object includes: a drive unit configured to drive wheels of a moving object body; a plurality of distance measuring units installed to face a road surface and configured to measure a distance to the road surface; a control unit configured to compare the distance measured by the distance measuring units with a threshold value and to control the drive unit; a tilt angle detecting unit configured to detect a tilt angle of the moving object body; and a correction unit configured to correct at least one of the distance measured by each distance measuring unit and the threshold value depending on the tilt angle of the moving object body detected by the tilt angle detecting unit.

A second aspect of the invention relates to a control method of an autonomous moving object. The control method of an autonomous moving object includes: measuring distances to a road surface; comparing the measured distances and a threshold value and controlling driving of the autonomous moving object; detecting a tilt angle of a moving object body; and correcting, at least one of the measured distances and the threshold value depending on the detected tilt angle of the moving object body.

A third aspect of the invention relates to a non-transitory recording medium having a control program of an autonomous moving object. The control program includes: a process of comparing distances to a road surface measured from the autonomous moving object and a threshold value and controlling driving of the autonomous moving object; a process of detecting a tilt angle of a moving object body; and a process of correcting at least one of the measured distances and a threshold value depending on the detected tilt angle of the moving object body.

According to the first to third aspects of the invention, it is possible to provide an autonomous moving object that can accurately detect a level difference even in a state where the autonomous moving object is tilted, a control method thereof, and a non-transitory recording medium thereof.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a side view schematically illustrating a configuration of an autonomous moving object according to an embodiment of the invention;

FIG. 2 is a block diagram illustrating a system configuration of the autonomous moving object according to the embodiment of the invention;

FIG. 3 is a top view of the autonomous moving object according to the embodiment of the invention when viewed from the top side;

FIG. 4 is a diagram illustrating a state where the autonomous moving object according to the embodiment of the invention runs on a convex part and is tilted;

FIG. 5 is a diagram illustrating positions of distance points in the embodiment of the invention;

FIG. 6 is a diagram illustrating an example where distance sensors other than distance sensors in the running direction are selected in the embodiment of the invention;

FIG. 7 is a diagram illustrating an example where distance sensors measuring a horizontal plane area are selected in the embodiment of the invention;

FIG. 8 is a diagram illustrating a control method when the autonomous moving object according to the embodiment passes over a convex part;

FIG. 9 is a diagram illustrating a control method when the autonomous moving object according to the embodiment passes over a convex part;

FIG. 10 is a diagram illustrating a control method when the autonomous moving object according to the embodiment passes over a convex part; and

FIG. 11 is a flowchart illustrating a control flow of the autonomous moving object according to the embodiment of the invention.

### DETAILED DESCRIPTION OF EMBODIMENTS

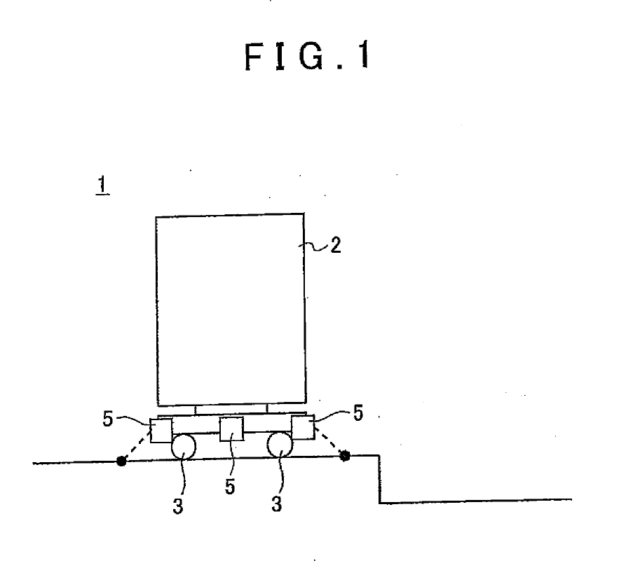

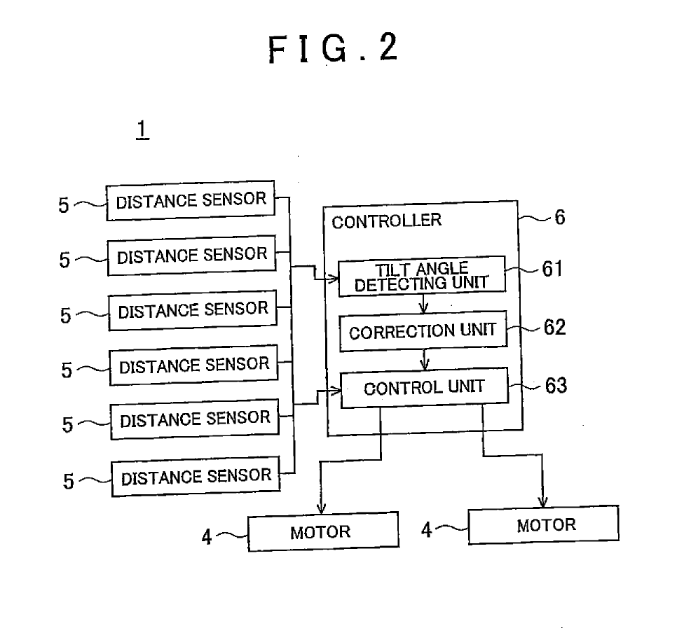

Hereinafter, an embodiment of the invention will be described with reference to the accompanying drawings. FIG. 1 is a side view schematically illustrating a configuration of an autonomous moving object according to an embodiment of the invention. FIG. 2 is a block diagram illustrating a system configuration of the autonomous moving object according to this embodiment. The autonomous moving object 1 according to this embodiment includes a moving object body 2, plural wheels 3 disposed in the moving object body 2 so as to be rotatable, plural motors 4 (a specific example of the drive unit) driving the wheels 3, plural distance sensors 5 measuring a distance, and a controller 6 controlling the motors 4 on the basis of the distances measured by the distance sensors 5. The above-mentioned configuration of the autonomous moving object 1 is only an example and is not limited thereto, and any autonomous moving object may be employed.

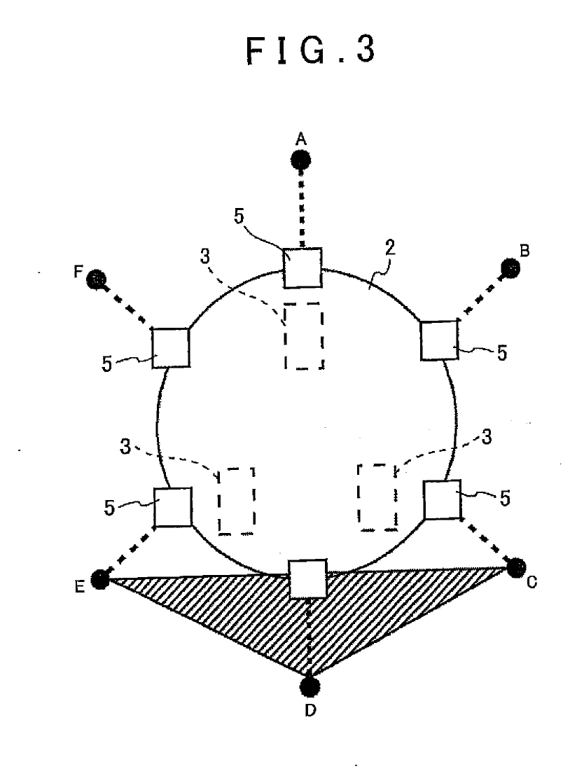

Each distance sensor 5 is a specific example of a distance measuring unit and is disposed to face a road surface in the running direction so as to measure the distance to the road surface. For example, six distance sensors 5 are arranged at equal intervals along the outer circumferential edge of the moving object body 2 (FIG. 3), but the invention is not limited to this example. The number of distance sensors and the positions thereof are not particularly limited as long as each distance sensor 5 is disposed to face the road surface in the running direction so as to measure the distance to the road surface. Each distance sensor 5 outputs the measured distance to the controller 6. Examples of the distance sensor 5 include an ultrasonic sensor, a millimeter wave sensor, and an infrared sensor.

The controller 6 compares the distances measured by the distance sensors 5 with a predetermined threshold value and controls the motors 4. The controller 6 detects a level difference, for example, when the distances to the road surface measured by the distance sensors 5 are greater than the threshold value. The controller 6 controls the motors 4 so as to stop the autonomous moving object 1 or to avoid the level difference on the basis of the detected level difference.

The controller 6 is constituted by hardware such as a microcomputer including a central processing unit (CPU) performing a control process, a calculation process, and the like, a read only memory (ROM) storing a control program, a calculation program, and the like which are executed by the CPU, a memory including a random access memory (RAM); and an interface unit (IF) inputting and outputting signals from and to the outside. The CPU, the memory, and the interface unit are connected to each other via a data bus or the like.

When the autonomous moving object 1 runs on a convex part and is tilted, the distances measured by the distance sensors increase (FIG: 4) in comparison with the case where the autonomous moving object runs on a horizontal road surface. Accordingly, in spite of absence of a concave stepped portion, the distances measured by the distance sensors may be greater than the threshold value and a concave stepped portion may be erroneously detected. On the contrary, the autonomous moving object 1 according to this embodiment detects a tilt angle α of the moving object body 2 and corrects at least one of the distance measured by each distance sensor 5 and the threshold value depending on the detected tilt angle α of the moving object body 2. Accordingly, even in the state where the autonomous moving object runs on a convex part and is tilted, it is possible to accurately detect the distances without erroneously detecting the above-mentioned concave stepped portion.

The controller 6 includes a tilt angle detecting unit 61 detecting the tilt angle α of the moving object body 2, a correction unit 62 correcting at least one of the distance measured by each distance sensor 5 and the threshold value, and a control unit 63 controlling the motors 4 on the basis of the distances and threshold value corrected by the correction unit 62.

The tilt angle detecting unit 61 is a specific example of the tilt angle detecting unit and detects the tilt angle α of the moving object body 2, for example, on the basis of the distances measured by three distance sensors 5 out of six distance sensors 5. More specifically, the tilt angle detecting unit 61 calculates a plane equation (ax+by+cz+d=0) on the basis of the distances measured by the three distance sensors 5.

For example, as illustrated in FIG. 3, the six distance sensors 5 measure the distances to distance points A to F, respectively. Here, it is assumed that the tilt angle detecting unit 61 calculates the plane equation of the distance points C, D, and E. For example, the tilt angle detecting unit 61 calculates coordinates (Xe, Ye, Ze) of the distance point E on the basis of the following equation:

Xe=(d cos φ+R)·cos θYe=(d cos φ+R)·sin θZe=sin φ.

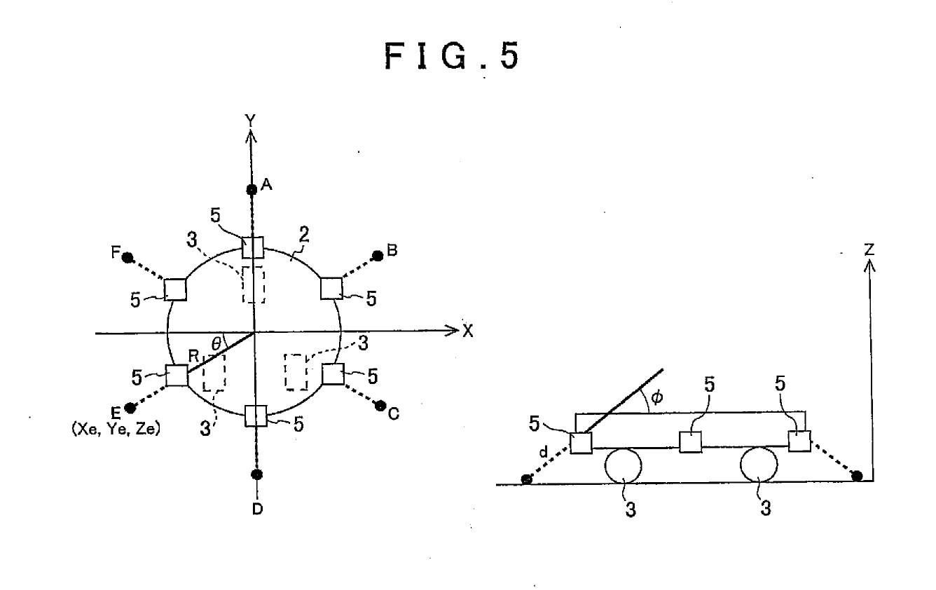

In the above-mentioned expression, when the center of the moving object body 2 is defined as an origin, the distance from the origin to each distance sensor 5 is defined as R, an angle formed by a line connecting each distance sensor 5 to the origin and the X axis is defined as θ, the distance measured by each distance sensor 5 is defined as d, and a depression angle is defined as φ (FIG. 5).

The tilt angle detecting unit 61 calculates the coordinates of the distance points C, D in the same way as the coordinate of the distance point E and substitutes the calculated coordinates of the distance points C, D, and E for the plane equation (ax+by+cz+d=0). The tilt angle detecting unit 61 calculates a plane including the distance points C, D, and E by calculating the coefficients a to d. The tilt angle detecting unit 61 further calculates the normal line of the calculated plane. The tilt angle detecting unit 61 detects the calculated normal line as the tilt angle α of the moving object body 2. The tilt angle detecting unit 61 outputs the detected tilt angle α of the moving object body 2 to the correction unit 62.

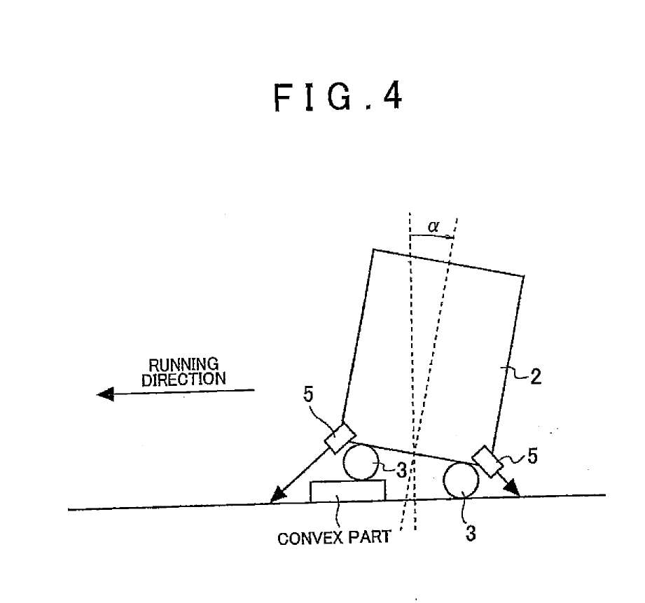

The correction unit 62 corrects at least one of the distance measured by each distance sensor 5 and the threshold value depending on the tilt angle α of the moving object body 2 detected by the a angle detecting unit 61. Here, as described above, when the autonomous moving object runs on a convex part and the moving object body is tilted, the distances measured by the distance sensors increase (FIG. 4), in comparison with the case where the autonomous moving object runs on a horizontal road surface. The larger the tilt angle of the moving object body becomes, the larger the distances measured by the distance sensors become.

Therefore, for example, the correction unit 62 performs a correction operation of decreasing the distance measured by eash distance sensor 5 as the tilt angle α of the moving object body 2 detected by the tilt angle detecting unit 61 increases. Alternatively, for example, the correction unit 62 performs a correction operation of increasing the threshold value as the tilt angle α of the moving object body 2 detected by the tilt angle detecting unit 61 increases. Accordingly, it is possible to correct the increase in the distance of each distance sensor 5 generated due to the tilt angle α of the moving object body 2.

The correction unit 62 performs the correction operation on the distance or the threshold value of the distance sensor 5 other than the distance sensors 5 used to detect the tilt angle of the tilt angle detecting unit 61. For example, as illustrated in FIG. 4, the tilt angle detecting unit 61 detects the tilt angle α of the moving object body 2 on the basis of the distance measured by the distance sensor 5 on the rear side in the running direction. The correction unit 62 corrects at least one of the distance measured by each distance sensor 5 on the front side in the running direction and the threshold value depending on the tilt angle α of the moving object body 2 detected by the tilt angle detecting unit 61.

The control unit 63 is a specific example of the control unit, compares the distance of each distance sensor 5 corrected by the correction unit 62 with the threshold value or compares the distance measured by each distance sensor 5 with the threshold value corrected by the correction unit 62, and controls the motors 4. The control unit 63 detects a level difference, for example, when the distance of each distance sensor 5 corrected by the correction unit 62 is greater than the threshold value.

Here, a method of selecting three distance sensors S for calculating a plane in the tilt angle detecting unit 61 will be described below in details.

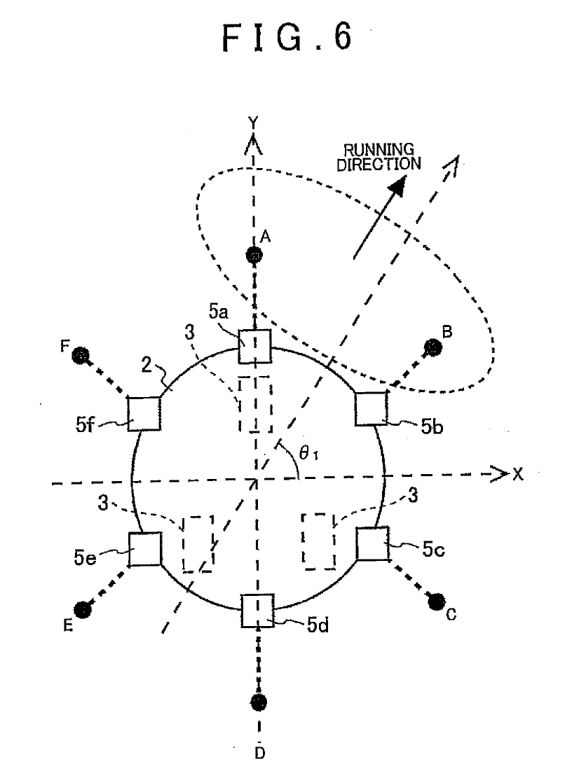

(1) When the distance sensors other than in the running direction are selected, for example, as illustrated in FIG. 6, the distance sensors 5a, 5b disposed on the front side in the running direction of the autonomous moving object 1 are necessary for detecting a level difference which is present on the front side in the running direction. Accordingly, the tilt angle detecting unit 61 detects the tilt angle α of the autonomous moving object 1 using the distances of the three distance sensors 5c to 5f out of the distance sensors 5c to 5f other than the distance sensors 5a, 5b disposed on the front side in the running direction.

The tilt angle detecting unit 61 calculates the angle θ1 in the running direction of the autonomous moving object 1, for example, on the basis of rotation information of each wheel detected by a rotation sensor. The tilt angle detecting unit 61 compares the calculated angle θ1 of the running direction of the autonomous moving object 1 with predetermined attachment angles θA to θF of the distance sensors 5a to 5f.

Here, when the autonomous moving object 1 is viewed from the top side, the center of the autonomous moving object is defined as an origin, a line passing through the distance sensors 5a, 5d is defined as the Y axis, and a line passing through the origin and perpendicular to the Y axis is defined as the X axis. The angle formed by the vector line in the running direction and the X axis is defined as the angle θ1 of the running direction, an angle formed by a line connecting the attachment position of each distance sensor 5a to 5f and the origin and the X axis is defined as the attachment angles θA to θF of the distance sensors 5a to 5f. The tilt angle detecting unit 61 sets the distance sensors 5a to 5f, in which the difference between the calculated angle θ1 in the running direction of the autonomous moving object 1 and the attachment angle θA to θF of the corresponding distance sensor 5a to 5f is less than the threshold value, as the distance sensor 5a to 5f disposed in the moving direction. The tilt angle detecting unit 61 selects the distances of three arbitrary distance sensors 5a to 5f out of the distance sensors 5a to 5f other than distance sensors 5a to 5f disposed in the running direction, and detects the tilt angle α of the moving object body 2 on the basis of the selected distance.

(2) When the distances sensors for measuring a horizontal plane area are selected, the tilt angle detecting unit 61 may detect the tilt angle α of the moving object body 2 on the basis of the distances of the distance sensors 5a to 5f for measuring the horizontal plane area determined already to be a horizontal road surface. The tilt angle detecting unit 61 detects the tilt angle α of the moving object body 2 on the basis of the distance sensors 5a to 5f for measuring the horizontal plane area determined to be the horizontal plane of the road surface on the basis of the distances measured in advance by the distance sensors 5a to 5f.

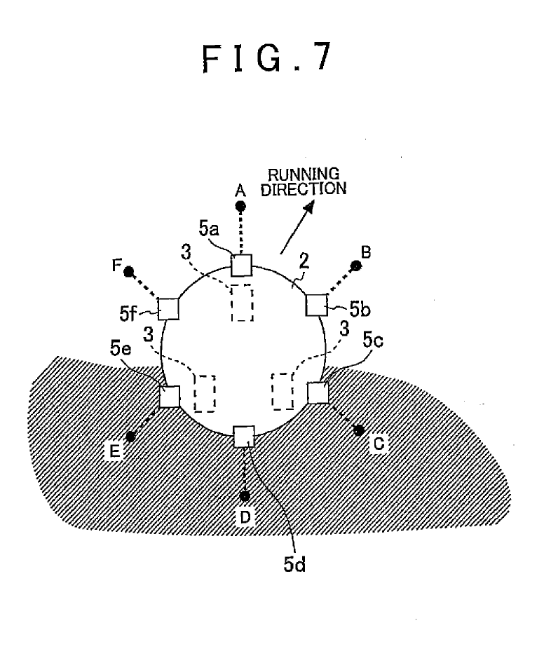

For example, as illustrated in FIG. 7, the autonomous moving object 1 identifies the road surface (road surface (hatched portion) on the rear side in the running direction of the autonomous moving object 1, which is hereinafter referred to as an existing road surface) on which the autonomous moving object 1 has ran. Accordingly, when the existing road surface is a horizontal plane area, the tilt angle detecting unit 61 detects the tilt angle α of the moving object body 2 on the basis of the distances of the distance sensors 5c, 5d, and 5e for measuring the horizontal road surface. Accordingly, it is possible to detect the tilt angle α of the object body 2 with high accuracy using the distance points C, D, and E present on the horizontal plane.

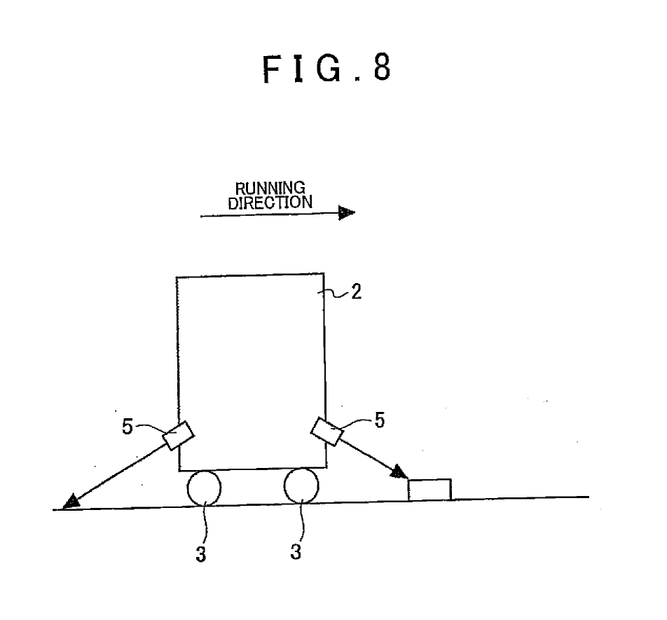

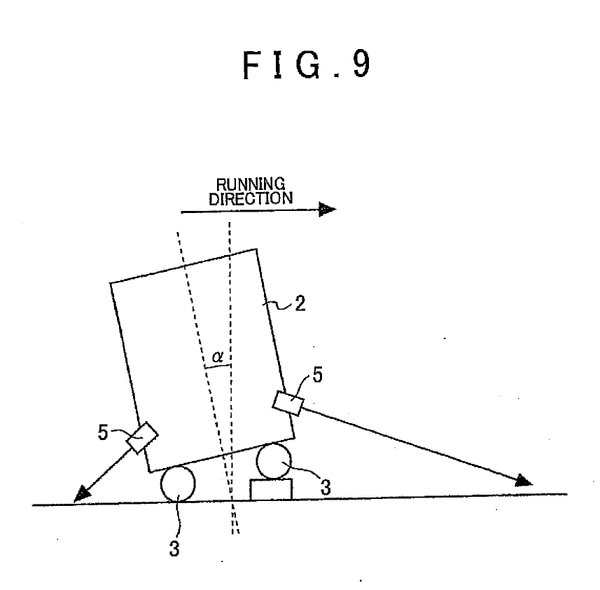

(3) When the autonomous moving object runs on a convex part, for example, as illustrated in FIG. 8, the controller 6 determines that the autonomous moving object can run on the convex part on the basis of the distance of the convex part detected by the distance sensors 5 on the front side in the running direction, and controls the motor 4 so as to run on the convex part. Subsequently, as illustrated in FIG. 9, when the front wheels 3 of the autonomous moving object 1 ran over the convex part, the tilt angle detecting unit 61 detects the tilt angle α of the moving object body 2 on the basis of the distances detected by the distance sensors 5 on the rear side in the running direction. Then, the correction unit 62 corrects the distance or the threshold value of each distance sensor 5 on the front side in the running direction on the basis of the tilt angle α detected by the tilt angle detecting unit 61.

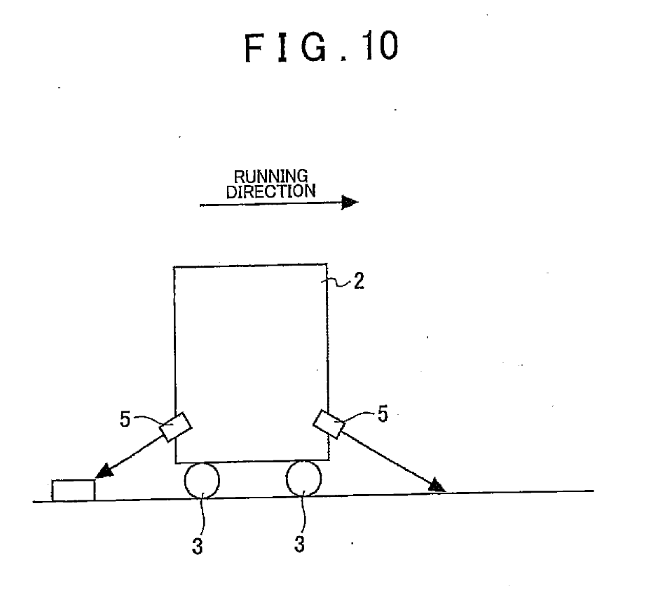

As illustrated in FIG. 10, the front and rear wheels 3 of the autonomous moving object 1 pass over the convex part, and then the tilt angle detecting unit 61 stops the detecting the tilt angle α of the moving object body 2 for a predetermined time (time in which the distance sensors 5 on the rear side in the running direction measure the convex part). Accordingly, the correction unit 62 stops the correcting of the distance measured by each distance sensor 5 on the rear side in the running direction and the threshold value for the predetermined time.

The tilt angle detecting unit 61 detects the tilt angle α of the moving object body 2 on the basis of the distances of the distance sensors 5 on the rear side in the running direction after the predetermined time passes. The correction unit 62 corrects at least one of the distance of each distance sensor 5 on the front side in the running direction and the threshold value on the basis of the tilt angle α of the moving object body 2 detected by the tilt angle detecting unit 61.

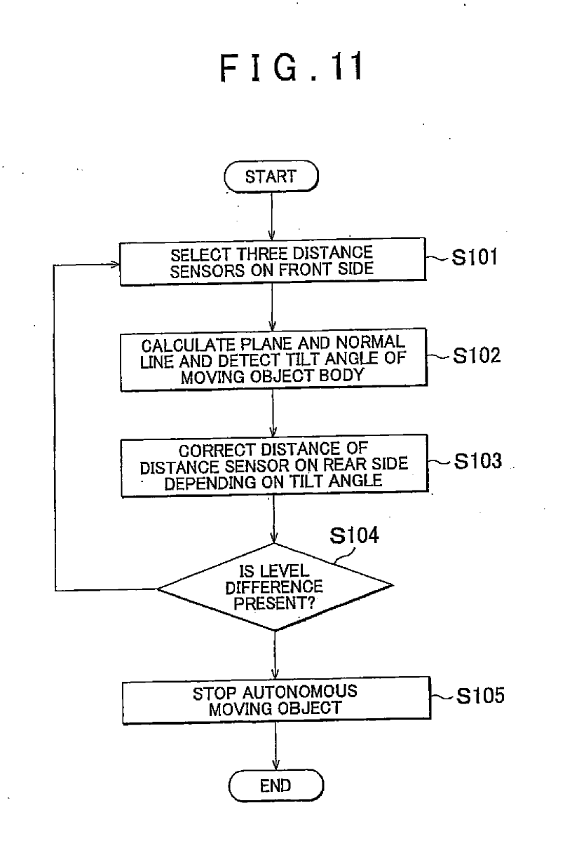

FIG. 11 is a flowchart illustrating a control flow of the autonomous moving object according to this embodiment. The tilt angle detecting unit 61 selects, for example, three distance sensors 5 on the rear side in the running direction out of the six distance sensors 5 on the basis of the running direction of the autonomous moving object (step S101).

The tilt angle detecting unit 61 calculates a plane on the basis of the distances measured by the three selected distance sensors 5 on the rear side in the running direction and calculates the normal line of the calculated plane. Then, the tilt angle detecting unit 61 detects the nit angle α of the moving object body 2 (step S102) on the basis of the calculated normal line. The correction unit 62 corrects, for example, the distances measured by the distance sensors 5 on the front side in the running direction depending on the tilt angle α of the moving object body 2 detected by the tilt angle detecting unit 61 (step S103).

The control unit 63 compares the distances of the distance sensors 5 on the front side in the running direction corrected by the Correction unit 62 with the threshold value and determines whether a level difference is present (step S104). When it is determined that a level difference is present (YES in step S104), the control unit 63 controls the motors 4, for example, so as to stop the autonomous moving object 1 (step S105). On the other hand, when it is determined that a level difference is not present (NO in step S104), the control unit 63 returns the control flow to step S101.

As described above, the autonomous moving object 1 according to this embodiment detects the tilt angle α of the moving object body 2 and corrects at least one of the distance measured by each distance sensor 5 and the threshold value depending on the detected tilt angle α of the moving object body 2. Accordingly, it is possible to accurately detect the distances without erroneously detecting the concave stepped portion even in the state where the autonomous moving object 1 runs on the convex part and is tilted.

The invention is not limited to the above-mentioned embodiment, but can be appropriately Modified in various forms without departing from the gist thereof. For example, in the above-mentioned embodiment, the tilt angle detecting unit 61 detects the tilt angle α of the moving object body 2 on the basis of the distances measured by the distance sensors 5, but the invention is not limited to this example. The tilt angle detecting unit 61 may detect the tilt angle α of the moving object body 2, for example, on the basis of sensor values measured by a gyro sensor disposed in the moving object body 2.

According to the embodiment of the invention, for example, the control flow illustrated in FIG. 11 is implemented by causing the CPU to execute a computer program.

The program can be supplied to a computer in a state where the program is stored on various types of non-transitory computer readable mediums. The non-transitory computer-readable medium includes various types of tangible storage mediums. Examples of the non-transitory computer-readable medium include a magnetic recording medium (such as a flexible disk, magnetic tape, or a hard disk drive), a magneto-optical recording medium (such as a magneto-optical disc), a CD-ROM (Read Only Memory), a CD-R, a CD-R/W, and a semiconductor memory (such as a mask ROM, a programmable ROM (PROM), erasable PROM (EMPROM), flash ROM, a random access memory (RAM)).

The program may be supplied to a computer through the use of various types of transitory computer-readable mediums. Examples of the transitory computer-readable medium include electric signals, optical signals, and electromagnetic waves. The transitory computer-readable medium can supply the program to a computer via a wired communication path such as an electrical cable or an optical fiber or a wireless communication path.

What is claimed is:

1. An autonomous moving object comprising:
a drive unit configured to drive wheels of a moving object body;
a plurality of distance measuring units installed to face a road surface and configured to measure a distance to the road surface;
a control unit configured to compare the distance measured by the distance measuring units with a threshold value and to control the drive unit;
a tilt angle detecting unit configured to detect a tilt angle of the moving object body; and
a correction unit configured to correct at least one of the distance measured by each distance measuring unit and the threshold value depending on the tilt angle of the moving object body detected by the tilt angle detecting unit.

2. The autonomous moving object according to claim 1, wherein the correction unit performs a correction operation of increasing or decreasing at least one of the distance measured by each distance measuring unit and the threshold value as the tilt angle of the moving object body detected by the tilt angle detecting unit increases.

3. The autonomous moving object according to claim 1, wherein the plurality of distance measuring units includes at least three distance sensors, and
wherein the tilt angle detecting unit calculates a plane based on the distances detected by the at least three distance sensors, calculates a normal line of the calculated plane, and detects the tilt angle of the moving object body based on the calculated normal line.

4. The autonomous moving object according to claim 1, wherein the tilt angle detecting unit detects the tilt angle of the moving object body based on the distance measured by the distance measuring unit disposed on a rear side of the moving object body in a running direction.

5. The autonomous moving object according to claim 4, wherein the correction unit corrects at least one of the distance measured by the distance measuring unit disposed on a front side of the moving object body in the running direction and the threshold value depending on the tilt angle detected by the tilt angle detecting unit.

6. The autonomous moving object according claim 1, wherein the tilt angle detecting unit detects the tilt angle of the moving object body based on the distance measured by the distance measuring unit measuring a horizontal plane area which is determined to be a horizontal plane in the road surface based on the distances measured by the distance measuring units.

7. A control method of an autonomous moving object, comprising:
measuring distances from the autonomous moving object to a road surface;
comparing the measured distances and a threshold value and controlling driving of the autonomous moving object;
detecting a tilt angle of a moving object body; and
correcting at least one of the measured distances and the threshold value depending on the detected tilt angle of the moving object body.

8. A non-transitory recording medium having a control program of an autonomous moving object, wherein the control program includes:
a process of comparing distances to a road surface measured from the autonomous moving object and a threshold value and controlling driving of the autonomous moving object;
a process of detecting a tilt angle of a moving object body; and
a process of correcting at least one of the measured distances and a threshold value depending on the detected tilt angle of the moving object body.
